(19) United States
(12) Patent Application Publication
(10) Pub. No.: US 2011/0282798 A1
(43) Pub. Date: Nov. 17, 2011

(54) Making Friend and Location Recommendations Based on Location Similarities

(75) Inventors: Yu Zheng, Beijing (CN); Xing Xie, Beijing (CN); Wei-Ying Ma, Beijing (CN)

(73) Assignee: MICROSOFT CORPORATION, Redmond, WA (US)

(21) Appl. No.: 13/154,806

(22) Filed: Jun. 7, 2011

Related U.S. Application Data
(63) Continuation of application No. 12/332,371, filed on Dec. 11, 2008.

(51) Int. Cl. G06Q 99/00

(52) U.S. Cl. 705/319

(57) ABSTRACT

Method for making a recommendation to a first user in a computing network, including calculating one or more similarity scores between the first user and one or more remaining users in the network, identifying a portion of the remaining users having a highest similarity scores, identifying one or more locations visited by the portion of the remaining users but not by the first user, determining an interest level of the first user in each location, ranking the locations based on the interest levels, and displaying the locations based on the ranking as a first recommendation.

### CROSS-REFERENCE TO RELATED APPLICATION

This is a continuation of U.S. patent application Ser. No. 12/332,371, filed Dec. 11, 2008, now pending, the disclosure of which is incorporated herein by reference in its entirety.

### BACKGROUND

The increasing popularity of location-acquisition technologies, such as Global Positioning Systems (GPS) and Global System for Mobile communications (GSM) networks, etc, is leading to the collection of large spatio-temporal dataset of many individuals. This dataset provides the opportunity of discovering valuable knowledge about users' movement behaviors including basic information, such as distance, duration and velocity etc, of a particular route. This knowledge may be used to find similarities between users because people who have similar location histories might share similar interests and preferences. Therefore, the more location histories the users shared, the more correlated these users would be.

### SUMMARY

Described herein are implementations of various techniques for making friend and location recommendations based on location histories. In one implementation, a computer application may receive a similarity score for one or more agents on a computing network. The similarity scores may be based on the similarities between the locations visited by the user and the locations visited by each agent. In one implementation, the computer application may rank each agent according to its similarity scores and identify the top few agents as the user's potential friends.

The computer application may then analyze the location histories of the user and the user's potential friends to identify the locations visited by the potential friends but not by the user. In one implementation, the computer application may then infer the user's interest level in each of the unvisited locations using a collaborative-based filtering model. The collaborative-based filtering model may quantify the user's interest level using [insert common name of method described in step 550]. The computer application may then rank the locations according to its quantified values and make location recommendations to the user based on its ranking.

In another implementation, the computer application may analyze each location and determine the content of each location to make a recommendation to the user. Here, the computer application may combine a content-based model of each location with a collaborative filtering model to make location recommendations to the user. In one implementation, the computer application may characterize each location or geospatial region by describing the content or specific attractions that may exist in the region. For example, the computer application may describe each region in terms of the number of restaurants, entertainment, sports, and travel destinations that may exist therein. Using the types of destinations present in the area, the computer application may infer the user's interest level in the region based on the user's interest in the types of destination that exist in the region.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for creating a hierarchal graph to model one or more users' location histories in accordance with one or more implementations of various techniques described herein.

FIG. 3 illustrates a schematic diagram that represents the process for creating a hierarchal graph in accordance with one or more implementations of various techniques described herein.

FIG. 4 illustrates a flow diagram of a method for determining user similarities based on location histories in accordance with one or more implementations of various techniques described herein.

FIG. 5 illustrates a flow diagram of a method for making friend and location recommendations based on location histories in accordance with one or more implementations of various techniques described herein.

### DETAILED DESCRIPTION

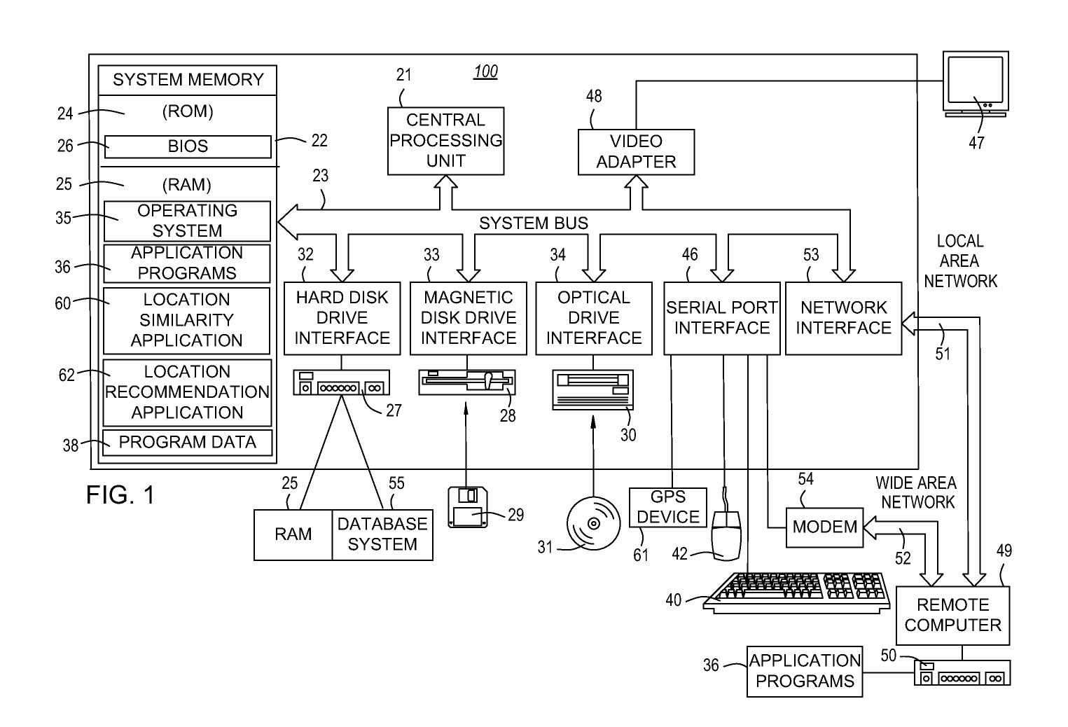

In general, one or more implementations described herein are directed to determining user similarities based on location histories. One or more implementations of various techniques for determining user similarities based on location histories will now be described in more detail with reference to FIGS. 1-5 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

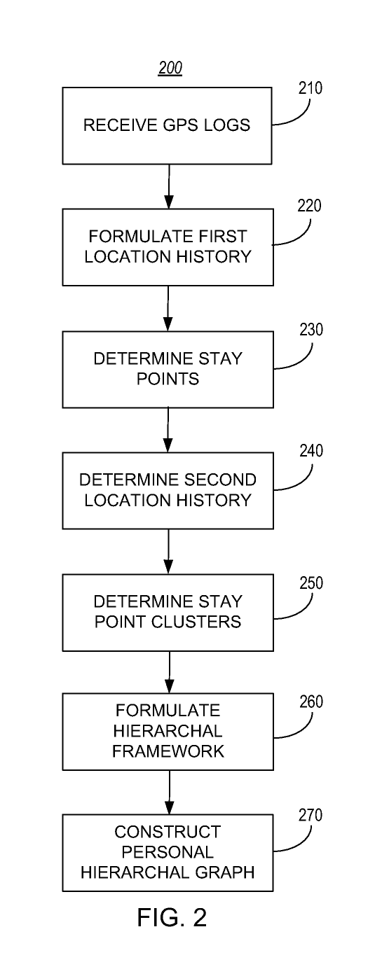

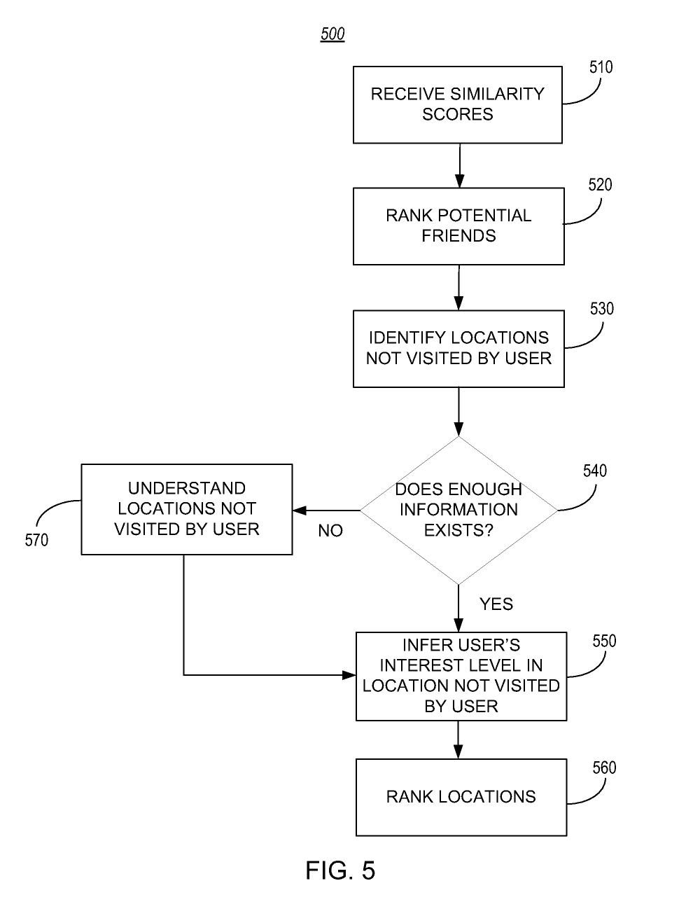

A number of program modules may be stored on the hard disk 27, magnetic disk 29, optical disk 31, ROM 24 or RAM 25, including an operating system 35, one or more application programs 36, a location similarity application 60, location recommendation application 62, program data 38, and a database system 55. The operating system 35 may be any suitable operating system that may control the operation of a networked personal or server computer, such as Windows® XP, Mac OS® X, Unix-variants (e.g., Linux® and BSD®), and the like. The location similarity application 60 may be an application that may enable a user to determine the similarities of two or more users based on their location histories. The location recommendation application 62 may be an application that may be capable of recommending friends and locations to a user based on the similarities between two or more users' location histories. The location similarity application 60 will be described in more detail with reference to FIGS. 2-4 in the paragraphs below. The location recommendation application 62 may be described more detail with reference to FIG. 5 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). The Global Positioning System (GPS) device 61 may be connected to the computing system 100 via the serial port interface 46. The GPS device 61 may include location data pertaining to the locations that a user may have traveled. The location data may be uploaded to the computing system 100 via the serial port interface and system bus 23 to the system memory 22 or the hard disk drive 27 for storage. A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for creating a hierarchal graph to model one or more users' location histories in accordance with one or more implementations of various techniques described herein. The following description of method 200 is made with reference to computing system 100 of FIG. 1 in accordance with one or more implementations of various techniques described herein. Additionally, it should be understood that while the operational flow diagram indicates a particular order of execution of the operations, in some implementations, certain portions of the operations might be executed in a different order. In one implementation, the process for creating a hierarchal graph to model one or more users' location histories may be performed by the location similarity application 60.

At step 210, the location similarity application 60 may receive one or more GPS logs from two or more users in a computing network that may be stored on the GPS device 61, the system memory 22, the hard disk drive 27, or a similar memory storage device. The GPS logs may include GPS location information, such as a pair of latitude and longitude coordinates for each location visited by a user and a corresponding time stamp indicating when each coordinate pair was visited.

At step 220, the location similarity application 60 may formulate a GPS trajectory or a first location history from the GPS logs for two or more users. The first location history may describe the path in which a user may have traveled and include a display of a list of latitude and longitude coordinate pairs placed in chronological order according to its time stamps. In one implementation, the location similarity application 60 may extract each latitude and longitude coordinate pair (GPS coordinates) and time stamps of these coordinate pairs from the GPS log of a user. The location similarity application 60 may then represent each pair of latitude and longitude coordinates as a node on a graph or map. The location similarity application 60 may connect each node on the graph with an arrow such that the arrow may be directed from one node to the subsequent node visited by the user. The nodes may also include the time stamps that correspond to the coordinates.

At step 230, the location similarity application 60 may determine the stay points of one or more GPS logs. The stay point may refer to a virtual location that may be in the center of a geographical region where a user may have stayed over a certain time interval. The determination of the stay point may depend on a distance threshold (Dₜₕᵣₑₛₕ) and a time threshold (Tₜₕᵣₑₛₕ). In one implementation, the stay point may be regarded as a virtual location characterized by a group of nodes where the distance between the each node may be less than the distance threshold and the time interval between the first node and the last node in the group may be greater than the time threshold (∀m<i≦n, Distance(pₘ,pᵢ)≦Dₜₕᵣₑₕ and |pₙ·T−pₘ·T|≧Tₜₕᵣₑₕ). In one implementation, the stay point may be generated by finding the average of the latitude coordinates of the group of nodes and the average of the longitude coordinates of the group of nodes. The stay point may then be considered to have the latitude coordinate and the longitude coordinate equal to the average of the latitude coordinates and the average of the longitude coordinates of the group of nodes.

In one implementation, each stay point (Sᵢ) may be described by a set of data including a latitude coordinate, a longitude coordinate, an arrival time, and a departure time, or S=[Latitude coordinate (Lat), Longitude coordinate (Lngt), arrival Time (arv), departure Time (dep)], where

staypoint latitude (Lat)=Σ_{I=m}ⁿp_{i ·Lat/|}P|

staypoint longitude (Lngt)=Σ_{I=m}ⁿp_{i ·Lngt/|}P|

staypoint arrival time (arv)=pₘ·T

staypoint departure time (dep)=pₙ·T

Here, P may represent a collection of GPS points P={p₁, p₂, . . . , pₙ}, and each GPS point pᵢεP may contain a latitude (pᵢ·Lat), a longitude (pᵢ·Lngt) and a timestamp (pᵢ·T).

The stay point arrival and departure times may represent a time that a user arrives at and departs from the stay point. Typically, stay points may be obtained when an individual remains stationary for a time that may exceed the time threshold (e.g., when individual enter a building and lose satellite signal over a time interval until coming back to outdoors) or when a user wanders around within a certain geo-spatial range for a period of time that may exceed the time threshold (e.g., when individual travel outdoors and are attracted by the surrounding environment).

At step 240, the location similarity application 60 may formulate a second location history with the stay points obtained at step 230. The second location history may include a record of stay points that a user may have visited over an interval of time. In one implementation, the second location history may include a sequence of stay points that may have been determined at step 230. The second location history may describe the location and an order in which a user may have visited one or more locations. The second location history (LocH) may be defined as:

$$LocH = ( {s}_{1} {\to }^{Δ {t}_{1}} {s}_{2} {\to }^{Δ {t}_{2}} , … , {\to }^{{Δt}_{n - 1}} {s}_{n} ) , \\ where {s}_{i} ∈ S and Δ {t}_{i} = {s}_{i + 1} \cdot arvT - {S}_{i} \cdot levT$$

where sᵢ may represent a particular stay point and Δtᵢ may represent the amount of time it took for a user to travel from one stay point to the next stay point.

At step 250, the location similarity application 60 may determine one or more clusters for all of the stay points determined at step 230. Each cluster may include one or more stay points that may be densely populated with a geographical area. In one implementation, the location similarity application 60 may collect all of the stay points of each GPS log stored in a memory and provide the collection of stay points to a density-based clustering algorithm to create one or more hierarchal clusters based on the geospatial regions of the stay points in the dataset.

In one implementation, a first cluster may include a maximum number of stay points that may encompass a large geographical area. The first cluster may be part of the highest layer of the hierarchal clusters. The density-based clustering algorithm may further locate one or more subclusters within the first clusters. Each subcluster may include one or more stay points that may be part of the first cluster; however, the stay points that may be part of the subcluster may include stay points that may be more densely populated than the stay points in the first cluster. The density-based clustering algorithm may locate additional subclusters within clusters depending on the proximity of one or more stay points. Each subcluster may represent a layer under the layer where its cluster may lay in the hierarchal clusters. In one implementation, each subcluster may represent a smaller geographical region than the cluster of which it may be part.

At step 260, the location similarity application 60 may formulate a hierarchal framework based on the clusters and subclusters determined at step 250. The hierarchal framework F may be defined as a collection of clusters C (and subclusters) on one or more layers L such that F=(C,L), where L={l₁,l₂, . . . , lₙ} denotes the collection of layers of the hierarchy, and C={cᵢⱼ|1≦i≦|L|, 0≦j<|Cᵢ|}, where cᵢⱼ represents the jth cluster of stay points S on layer lᵢεL, and Cᵢ is the collection of clusters on layer lᵢ. In one implementation, stay points from various users or GPS logs may be assigned to one or more clusters C on one or more layers L.

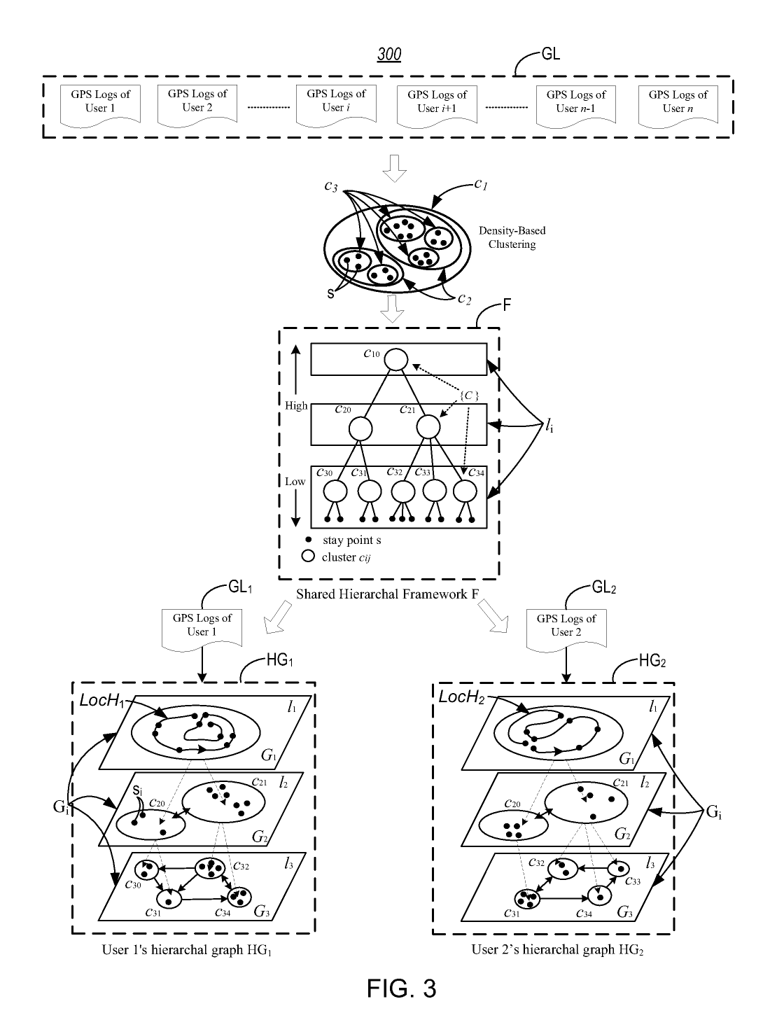

For example, a first cluster of stay points may include one or more subclusters within itself. Here, the first cluster may be considered to be on a top (high) layer of the hierarchal framework, and each sub-cluster within the first cluster may be considered to be on the same layer of the shared hierarchal framework which may be one layer below the first cluster's layer on the hierarchal framework. From the top to the bottom of the hierarchal framework, the geospatial scale of clusters decreases while the granularity of geographic regions may increase from being coarse to being fine. The hierarchical feature of this framework may be useful to differentiate people with different degrees of similarities. Therefore, the users who share the similar second location histories on a lower layer of the hierarchal framework may be more correlated than those who share second location histories on a higher layer. An example of the shared hierarchal framework is illustrated in FIG. 3.

At step 270, the location similarity application 60 may construct a personal hierarchal graph (HG) based on the hierarchical framework (F) and the second location history (LocH) of each user. The personal hierarchal graph HG may include one or more graphs describing the clusters or subclusters that a user may have traveled according to the user's second location history. In one implementation, the location similarity application 60 may cross-reference the second location history of a user with each layer of the hierarchal framework. The location similarity application 60 may map each of the user's stay points in the second location history to its respective cluster or subcluster in each layer of the hierarchal framework. A cluster or subcluster may then contain the user's stay points and an edge may connect two clusters or subclusters to represent the sequence in which the user may visit each cluster or subcluster (geographic regions). The personal hierarchal graph may include one or more graphs such that each graph may correspond to a layer of the hierarchal framework. Given a user's second location history and the hierarchal framework, the user's hierarchical graph may be formulated as a set of graphs describing HG={Gᵢ=(Cᵢ,Eᵢ),1<i≦|L|}, where on each layer lᵢεL, GᵢεHG, and a set of vertexes or clusters cᵢ and the edges Eᵢ may be connecting cᵢⱼε Cᵢ.

FIG. 3 illustrates a schematic diagram that represents the process 300 for creating a hierarchal graph in accordance with one or more implementations of various techniques described herein. The following description of the process 300 is made with reference to computing system 100 of FIG. 1 and the method 200 of FIG. 2 in accordance with one or more implementations of various techniques described herein. It should be understood that while the process 300 indicates a particular order of execution of the operations, in some implementations, certain portions of the operations might be executed in a different order. Additionally, the process 300 may correspond to some of the steps illustrated in FIG. 2.

In one implementation, the process 300 may include two or more GPS logs GL from two or more users, one or more clusters cᵢⱼ, one or more stay points S, a hierarchal framework F, one or more user hierarchal graphs HG, one or more second location histories, and one or more layers l. FIG. 3 illustrates an example of a hierarchal framework F and two user hierarchal graphs HG created for two users according to the method 200 described in FIG. 2.

Referring to step 210, the GPS logs GL may include one or more GPS logs GL of one or more users. In one implementation, GPS logs GL may be downloaded from the GPS device 61 and stored in a memory storage device accessible by the computing system 100.

Referring to step 230, the location similarity application 60 may create one or more nodes on a graph to represent the stay points S from the GPS logs GL. The stay points S may be represented by nodes as indicated in FIG. 3. In one implementation, the location similarity application 60 may determine the stay points S for each user's GPS log GL.

Referring to step 250, the location similarity application 60 may determine one or more clusters cᵢⱼ with the use of a density-based clustering algorithm. The location similarity application 60 may indicate a cluster cᵢⱼ on the graph by enclosing one or more stay points S inside a circle. The jth variable in the cluster cᵢⱼ may be numbered to distinguish each different cluster on a certain layer lᵢ of the shared hierarchal framework F, and the ith variable may correspond to the layer lᵢ in which the cluster cᵢⱼ may be placed. Within the cluster cᵢⱼ, the location similarity application 60 may find one or more subclusters c₍ᵢ₊₁₎ⱼ that may include a group of stay points S with a closer proximity to each other than the stay points S of the original cluster cᵢⱼ. Each subcluster c₍ᵢ₊₁₎ⱼ within a cluster cᵢⱼ may indicate a new level or layer lᵢ in the shared hierarchal framework F or the hierarchal graph HG. Each subcluster c₍ᵢ₊₁₎ⱼ may also be considered to be a cluster c₍ᵢ₊₁₎ⱼ if it contains two or more subclusters c_{(i+2) j} within itself. For example, in the process 300, cluster c₁ may represent the largest geographical area (layer lᵢ=1) of the clusters cᵢⱼ because it may encompass all of the stay points S from each GPS log GL. Subcluster c₂ may represent a subcluster (layer lᵢ=2) of the cluster c₁. Cluster c₃ may then represent a subcluster (layer lᵢ=3) of the cluster c₂. Each layer of the cluster cᵢⱼ may represent a step or layer in the shared hierarchal framework F or a separate graph that may be part of the hierarchal graph HG. The layers lᵢ may correspond to the proximity of the stay points S such that layer 1 (c₁) may correspond to a larger geographical region, and the lower layers (levels 2+) may correspond to an increasingly smaller geographical region.

Referring to step 260, the location similarity application 60 may formulate the shared hierarchal framework F by representing clusters cᵢⱼ according to the layer it may correspond to. For example, cluster c₁₀ may correspond to the cluster c₁, clusters c₂₀ and c₂₁ may correspond to the cluster c₂, and clusters c₃₀, c₃₁, c₃₂, c₃₃, and c₃₄ may correspond to the cluster c₃ referred to above. The stay points S may be represented inside each cluster cᵢⱼ on the lowest layer lᵢ of the hierarchal framework F.

Referring to step 270, the location similarity application 60 may formulate the hierarchal graph HG for a specific user. In one implementation, the location similarity application 60 may extract a user's clusters cᵢⱼ and stay points S from the hierarchal framework F according to the user's GPS log GL. Each cluster cᵢⱼ on a different layer lᵢ of the hierarchal framework F may correspond to a different graph Gᵢ.

In one implementation, the location similarity application 60 may determine the second location history LocH from the GPS log GL for a particular user. For example, the second location history LocH₁ for user 1 may be determined by organizing the stay points S of the GPS log Gl₁ for user 1 in a chronological order and connecting each stay point with a directed arrow. The hierarchal graph HG₁ may then be determined by mapping the second location history LocH₁ with the clusters cᵢⱼ in the hierarchal framework F that may include the stay points of the second location history LocH₁. The stay points S part of the second location history LocH₁ may be grouped as per the clusters cᵢⱼ listed in the hierarchal framework F. Each layer lᵢ of the hierarchal framework F may correspond to a graph Gᵢ of the hierarchal graph HG.

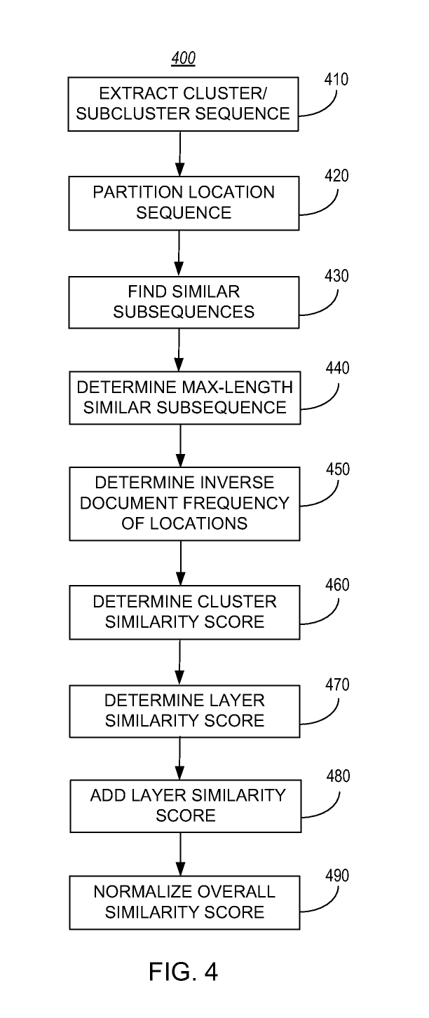

FIG. 4 illustrates a flow diagram of a method 400 for determining user similarities between two users based on location histories in accordance with one or more implementations of various techniques described herein. The following description of method 400 is made with reference to computing system 100 of FIG. 1 and process 300 of FIG. 3 in accordance with one or more implementations of various techniques described herein. Additionally, it should be understood that while the operational flow diagram indicates a particular order of execution of the operations, in some implementations, certain portions of the operations might be executed in a different order. In one implementation, the method for determining user similarities based on location histories may be performed by the location similarity application 60.

At step 410, the location similarity application 60 may extract a sequence of clusters cᵢⱼ or subclusters from each graph in the hierarchal graphs HG of the two users for whom similarities may be determined by the location similarity application 60. In one implementation, the hierarchical graph HG of each user may offer an effective representation of a user's second location history LocH, which may imply a sequence of the user's movement behavior based on geographic spaces of different scales. Given HG₁ and HG₂ of two users (u₁ and u₂) as indicated in FIG. 3, the location similarity application 60 may first locate one or more of the same graph vertexes Vᵢ^{1,2} shared by two users on each layer lᵢε L, where Vᵢ^{1,2}={cᵢⱼ|cᵢⱼεHG₁·Cᵢ∩HG₂·Cᵢ)}, 1≦i≦|L|. Then, on each layer lᵢε L, the location similarity application 60 may formulate a location history sequence for the two users (u₁ and u₂) based on the same graph vertexes Vᵢ^{1,2}. The same graph vertexes Vᵢ^{1,2} may correspond to the clusters cᵢⱼ that the two users may share.

The location similarity application 60 may then obtain the clusters cᵢⱼ that match the same graph vertexes Vᵢ^{1,2} for each graph of each user's hierarchal graph HG. The sequence the clusters cᵢⱼ (and subclusters) may be organized in a chronological order with respect to the all of the clusters cᵢⱼ traveled by each user. The clusters cᵢⱼ may be chronologically organized into a sequence of clusters cᵢⱼ (or subclusters) according to the time stamps of the stay points S within the clusters cᵢⱼ. The location similarity application 60 may then calculate the amount of time elapsed between each chronologically ordered cluster cᵢⱼ pair and store that information within the sequence of clusters cᵢⱼ for each user. For example, the sequence seqᵢ^{k} may denote the sequence of user uₖ on the ith layer of the hierarchal graph HGₖ, the transition time Δtᵢ may denote the time interval between consecutive items of these sequences, and ΔSᵢⱼ may denote the number of stay points S within the cluster cᵢⱼ. An example of the sequence see for users (u₁ and u₂) is listed below:

$${seq}_{3}^{1} = {c}_{32} ( Δ {S}_{32} ) {\to }^{Δ {t}_{1}} {c}_{31} ( Δ {S}_{31} ) {\to }^{Δ {t}_{2}} {c}_{33} ( Δ {S}_{33} ) {\to }^{Δ {t}_{3}} {c}_{32} ( Δ {S}_{32} ) {\to }^{Δ {t}_{4}} {c}_{33} ( Δ {S}_{33} ) {\to }^{Δ {t}_{5}} {c}_{32} ( Δ {S}_{32} )$$

$${seq}_{3}^{2} = {c}_{31} ( Δ {S}_{31}^{′} ) {\to }^{Δ {t}_{1}^{′}} {c}_{33} ( Δ {S}_{33}^{′} ) {\to }^{Δ {t}_{2}^{′}} {c}_{32} ( Δ {S}_{32}^{′} ) {\to }^{Δ {t}_{3}^{′}} {c}_{31} ( Δ {S}_{31}^{′} ) {\to }^{Δ {t}_{4}^{′}} {c}_{32} ( Δ {S}_{32}^{′} ) {\to }^{Δ {t}_{5}^{′}} {c}_{31} ( Δ {S}_{31}^{′} )$$

Here, two users' sequences become comparable because the clusters cᵢⱼ may be used rather than stay points S to represent the items of a sequence.

At step 420, the location similarity application 60 may partition the location history sequence obtained at step 410 into several subsequences. In one implementation, location similarity application 60 may partition the sequence because the number of similar sequences with a long length may be difficult to locate, while shorter length subsequences may provide a more efficient medium to locate similarities between two users. In one implementation, if the transition time Δtᵢ between consecutive clusters cᵢⱼ of the sequence seqᵢ^{k} may exceed a certain time period tₚ, e.g., 24 hours, the location similarity application 60 may split the sequence seqᵢ^{k} into two sequences. In one implementation, the location similarity application 60 may continue to partition the original location history sequence of the user multiple times until each shorter length location history sequence does not contain a transition time between consecutive clusters cᵢⱼ above the certain period tₚ.

At step 430, the location similarity application 60 may find one or more similar subsequences between two users with respect to the subsequences partitioned at step 420. In one implementation, the location similarity application 60 may find similar subsequences for one or more users, (uₚ,uₚ₊₁,uₚ₊₂, . . . ) that may have the similar subsequences with similar time intervals. For example, a pair of subsequences seqᵢ^{p} and seqᵢ^{q} may include:

$${seq}_{i}^{p} = < {a}_{1} ( {m}_{1} ) {\to }^{Δ {t}_{1}} {a}_{2} ( {m}_{3} ) {\to }^{Δ {t}_{2}} … {\to }^{{Δt}_{j - 1}} {a}_{j} ( {m}_{j} ) {\to }^{Δ {t}_{j}} … {\to }^{{Δt}_{n - 1}} {a}_{n} ( {m}_{n} ) > , \\ {seq}_{i}^{q} = < {b}_{1} ( {m}_{1}^{′} ) {\to }^{Δ {t}_{1}^{′}} {b}_{2} ( {m}_{2}^{′} ) {\to }^{Δ {t}_{2}^{′}} … {\to }^{{Δt}_{j - 1}^{′}} {b}_{j} ( {m}_{j}^{′} ) {\to }^{Δ {t}_{j}^{′}} … {\to }^{{Δt}_{n - 1}^{′}} {b}_{n} ( {m}_{n}^{′} ) > ,$$

where aⱼεVᵢ^{pq} is a cluster cᵢⱼ, Vᵢ^{pq}={cᵢⱼ|cᵢⱼεHG^{p}·Cᵢ∩HG^{q}·Cᵢ)},1≦i≦|L| is the graph vertexes shared by uₚ and u_{q} on layer lᵢ, mᵢ represents the times the user successively visits cluster aⱼ, and Δtₜ stands for the transition time the user traveled from cluster aᵢ to aⱼ₊₁. The location similarity application 60 may determine that sub sequences seqᵢ^{p} and seqᵢ^{q} are similar, if and only if they satisfy the following conditions:
1. ∀1≦j≦n,aⱼ=bⱼ, i.e., the nodes at the same position of the two sequences share the same cluster ID;
2. ∀1<j<n,

$$\frac{\vert Δ {t}_{j} - Δ {t}_{j}^{′} \vert}{max ( Δ {t}_{j} , Δ {t}_{j}^{′} )} \leq p ,$$

where p is a pre-defined ratio threshold, which may be referred to as temporal constraint. It denotes that the two users have similar transition times between same regions.
If both conditions are true, a similar subsequence sseqᵢ^{p,q} contained in the subsequence sect and the subsequence secqᵢ^{p} may be retrieved as listed below:

sseqᵢ^{p,q}=<a₁(min(m₁,m₁′))→a₂(m₂,m₂′))→ . . . aₙ(min(mₙ,m_{n′>,}

where min(mₗ,m₁′) may denote the minimal value between m₁ and m₁′.

At step 440, the location similarity application 60 may identify the similar subsequence sseq of the two users having a maximum number of clusters cᵢⱼ or subclusters in common. The similar subsequence sseq of the two users having a maximum number of clusters cᵢⱼ or subclusters in common may be referred to as the maximum-length similar subsequence. In one implementation, the location similarity application 60 may employ two operations to determine the maximum-length similar subsequence, subsequence extension and subsequence pruning, in determining the maximum number of clusters cᵢⱼ or subclusters that two users may have in common in two subsequences. In one implementation, the location similarity application 60 may first identify one or more subsequences or the two users that may include two clusters or subclusters (1-length similar subsequence) travelled by each user in the same chronological order. In the extension operation, the location similarity application 60 may then extend each m-length similar subsequence to a (m+1)-length similar subsequence. Subsequently, in the pruning operation, the location similarity application 60 may select the maximum-length similar subsequence from the candidates generated by the extension operation, and remove the other similar subsequences from a list of potential maximum-length similar subsequences. The extension and pruning operations may be implemented alternatively and iteratively until each cluster cᵢⱼ in the subsequence is scanned.

For example, the location similarity application 60 may begin by finding a 1-length similar subsequence from all of the partitioned subsequences obtained at step 420. The 1-length similar subsequence may include two clusters cᵢⱼ visited successively by the two users (u₁ and u₂). Upon locating one or more 1-length similar subsequences, the location similarity application 60 may add the 1-length similar subsequences to a list of potential maximal-length similar subsequence. Using the located 1-length similar subsequences, the location similarity application 60 may then compare an additional length of the located 1-length similar subsequences to determine if a 2-length similar subsequence may exist within the set of 1-length similar subsequences (extension operation). If any 2-length similar subsequences are found within the original 1-length similar subsequence, the location similarity application 60 may remove the 1-length similar subsequences (pruning operation) from its list of potential maximal-length similar subsequence and add the similar 2-length similar subsequence to the list. The location similarity application 60 may then continue to perform the extension and pruning operations alternatively and iteratively until the maximal-length similar subsequence is identified.

At step 450, the location similarity application 60 may determine the popularity of a stay point S or cluster cᵢⱼ. In one implementation, the location similarity application 60 may utilize an inverse document frequency (IDF) methodology to quantify the popularity of each geospatial region (stay point S or cluster cᵢⱼ) contained in the similar subsequence. The IDF of a cluster cᵢⱼ may be defined as

$${IDF}_{ij} = \frac{\vert U \vert}{{n}_{ij}} ,$$

where nᵢⱼ defines the number of users that may have visited the cluster cᵢⱼ and U defines the total number of users in the network. In order to use the IDF method, the location similarity application 60 may regard each cluster cᵢⱼ as a document, and the users that may have visited each cluster cᵢⱼ may represent descriptive terms in the document. If the number of users (nᵢⱼ) that may have visited a region (cluster cᵢⱼ) is very large, the

$${IDF}_{ij} = log \frac{\vert U \vert}{{n}_{ij}}$$

of this region would become very small. The IDF value for each location may be used to evaluate the importance or weight of a particular cluster cᵢⱼ.

For example, many users may visit the cluster cᵢⱼ that may include The Great Wall of China. However, a visit to The Great Wall of China may not provide relevant data pertaining to the location similarities between two users because The Great Wall of China is a very popular location that many users with a variety of location histories or interests may visit. The reputation of The Great Wall of China may attract a variety of users; therefore, this region may not offer much valuable information pertaining to the similarity score of these two users. However, if two users share a location history that may include one or more locations that may not be well-known or that may not be accessed by very many users, the two users may share more similar interests.

At step 460, the location similarity application 60 may determine a cluster similarity score ss_{q} for each cluster cᵢⱼ that may be part of a similar location subsequence sseq of two or more users. The cluster similarity score ss_{q} for each cluster cᵢⱼ may include a multiplication of two parts (IDFᵢⱼ×min (mₚ,m_{q})), where the (min (mₚ,m_{q})) may represent the times that two users may have successively accessed the clusters cᵢⱼ in the similar location subsequences. In addition, a length-dependent factor β may be used to distinguish the significance of similar subsequences with various lengths, len, such that the β=^{len-1}. In other words, the longer the similar location subsequence matched between two users' location histories, the more related these two users might be; hence, a higher weight or high score may be awarded to this similar subsequence.

At step 470, the location similarity application 60 may determine a layer similarity score ssₜ for each subsequence on a specific layer for each similar subsequence sseq on the layer 1. The layer similarity score ssₜ of the two users on the layer may include the sum of the cluster similarity scores ss_{q} on the specific layer. In one implementation, a layer-dependent factor α may be used to weigh the significance of similar subsequences found on different layers. For instance, the location similarity application 60 may use α=2ⁱ⁻¹. In other words, people who share a subsequence of places on a lower layer (with finer granularity) might be more related than others who share a subsequence of places on a higher layer (with coarse granularity).

At step 480, the location similarity application 60 may then add the layer similarity scores ssₗ of each layer on the personal hierarchal graph HG to determine the overall similarity score ss^{p,q} of the users.

At step 490, the location similarity application 60 may then normalize the calculated overall similarity score ss^{p,q} to provide a fair result to the users with various scales of GPS logs. In one implementation, the location similarity application 60 may divide the overall similarity score ss^{p,q} by the multiplication of the scales of their dataset (|S^{p}|×|S^{p}|). In a new network of users, some users may have more GPS logs provided to the application than others. The location similarity application 60 may be more likely to find similar locations visited by two users who may have provided many GPS logs than those who provided fewer GPS logs given the quantity of GPS information provided. It may be more likely for two users to have visited more similar locations given more locations listed in each GPS log; however, the increased likelihood of similar locations between two users may not accurately reflect the actual similarities between two users. Normalizing the data may allow for each user to be evaluated equally even if some users provide more GPS logs than other users. If the location similarity application 60 does not normalize the data, the users with more GPS logs supplied to the location similarity application 60 may continuously be recommended to others even though they may not be the most perfect candidates.

FIG. 5 illustrates a flow diagram of a method for determining friend and location recommendations based on location histories in accordance with one or more implementations of various techniques described herein. The following description of the method 500 is made with reference to computing system 100 of FIG. 1 and method 400 of FIG. 4 in accordance with one or more implementations of various techniques described herein. Additionally, it should be understood that while the operational flow diagram indicates a particular order of execution of the operations, in some implementations, certain portions of the operations might be executed in a different order. In one implementation, the method for determining friend and location recommendations based on location histories may be performed by the location recommendation application 62.

At step 510, the location recommendation application 62 may receive user similarity scores. In one implementation, the user similarity scores from two users (uₖ and uⱼ) may be received from the location similarity application 60 as described in FIGS. 2-4. The similarity scores between the two users may be used to formulate a similarity matrix (SM) where SM={ss^{k,j},1≦k≦|U|,1≦j≦|U|,j≠K}.

At step 520, the location recommendation application 62 may rank users according to their similarity scores with respect to the principal user. In one implementation, the location recommendation application 62 may use the user uₖ as a query item to retrieve information from the SM the vector v^{k} containing the overall similarity scores between uₖ and each user, where v^{k}=<ss^{kj},1≦j≦|U|,j≠k>. The location recommendation application 62 may then normalize the overall similarity score ss^{k,j} to a value between 0 and 1 such that:

$${ss}^{k , j} = \frac{{ss}^{k , j} - min ( {v}^{k} )}{Max ( {v}^{k} ) - min ( {v}^{k} )}$$

In one implementation, the location recommendation application 62 may display the top N number of users with relatively high overall similarity scores ss^{k,j} as user uₖ's potential friends U′, where U′⊂U,∀uⱼεU′,uₚεŪ′,ss^{k,j}>ss^{k,p.}

At step 530, the location recommendation application 62 may identify one or more locations visited by a user's potential friends U′ but not visited by the user. In one implementation, the location recommendation application 62 may evaluate each layer lᵢεL on each user's hierarchal graph and find a set of regions Rᵢ^{k} that may have been accessed by uₖ's potential friends U′ but may not have been visited by uₖ. Here, the regions Rᵢ^{k} may be defined as Rᵢ^{k}={cεCᵢ|r_{c}^{k}=Λ∃U′,r_{c}^{j}≠}m 1≦i≦|L|, where r_{c}^{k} represents uₖ's accesses (ratings) on geospatial region c. In one implementation, the location recommendation application 62 may create a sub-similarity matrix to describe information identifying each user, the locations visited by each user, and the number of times each location was visited by each user. Using the sub-similarity matrix, the location recommendation application 62 may identify the locations that may have been visited by the user's potential friends but not by the user.

At step 540, the location recommendation application 62 may determine if enough information exists to infer the user's interest level in the locations in which the user uₖ may not have visited. In one implementation, the location recommendation application 62 may determine that enough information does not exist if there are too few users in the network with similar location histories or similarity scores with respect to the user. If the location recommendation application 62 determines that there is enough information to infer the user's interest level in the unvisited locations, it may proceed to step 550, otherwise it may proceed to step 570.

In one implementation, the location recommendation application 62 may infer the user's interest level with a collaborative-based filtering model. However, if there are not enough users in the network or enough users with similar location histories in the network, the location recommendation application 62 may not have enough information to perform a collaborative-based filter to determine a user's interest level in a location. Therefore, the location recommendation application 62 may determine that there is not enough information to infer the user's interest level and will proceed to step 570.

At step 550, the location recommendation application 62 may infer the user's interest level in each location that may not have been visited by the user. In one implementation, the location recommendation application 62 may use a collaborative filtering-based method to infer the user's interest in each location. For example, the similarity between users uₖ and uⱼ, sim(uₖ,uⱼ), may be determined by the following equations:

$${r}_{c}^{k} = \overline{{r}^{k}} + d {\sum }_{{u}_{j} ∈ {U}^{′}} sim ( {u}_{k} , {u}_{j} ) \times ( {r}_{c}^{j} - \overline{{r}^{k}} ) ;$$

$$d = \frac{1}{\vert {U}^{′} \vert} {\sum }_{{u}_{j} ∈ {U}^{′}} sim ( {u}_{k} , {u}_{j} ) ;$$

$$\overline{{r}^{k}} = \frac{1}{\vert {C}^{′} \vert} {\sum }_{c ∈ {C}^{′}} {r}_{c}^{k} , {C}^{′} = \{ c ∈ {C}_{i} \vert {r}_{c}^{k} \neq \} ;$$

The similarity between users uₖ and uⱼ, sim(uₖ, uⱼ), may use a distance measured between two users as a weight in determining the similarities between two users, i.e., the more similar uₖ and uⱼ are, the more weight r_{c}^{j} will carry in the prediction of r_{c}^{k} where r_{c}^{j} represents uⱼ's accesses (ratings) on geospatial region c. In one implementation, the location recommendation application 62 may associate the number of visits or accesses to a particular geospatial region by the user uⱼ with an implicit rating of the user for the geospatial region. For example, if a user visits a particular geospatial region often, that region may have a higher rating than other regions visited by the user. C′ may represent uₖ's potential location recommendations. A normalizing factor d may be involved to ensure that the similarity measurement works well. The collaborative filtering-based method may quantify how interested a user may be in a potential location recommendation (C′) by calculating a value for each potential location recommendation (C′) using the equations listed above.

At step 560, the location recommendation application 62 may rank the potential location recommendations (C′) according to its value determined at step 550.

Referring back to step 540, if the location recommendation application 62 determines that there is not enough information to infer the user's interest level in the unvisited locations, the location recommendation application 62 may proceed to step 570. At step 570, the location recommendation application 62 may make an attempt to understand the locations not visited by the user uₖ. Understanding the unvisited location may provide the location recommendation application 62 with additional information pertaining to each unvisited location in order to provide a useful recommendation to the user uₖ. By understanding the profile of each geospatial region, the location recommendation application 62 may be able to combine a content-based model of each location with collaborative filtering to provide recommendations to the user uₖ given the lack of similar users in the network or information on each location. In one implementation, the location recommendation application 62 may understand the profiles of a geospatial region by exploring the concentration of Point Of Interests (POI) categories within the region. The POI categories may refer to the content of the geospatial region that may attract people to the region itself such as the existence of shopping malls, restaurants, and cinemas, etc, located in the region.

In one implementation, the location recommendation application 62 may investigate each location with respect to four POI categories such as restaurants (R), entertainment (ε), sports (S), and travel (T). For example, the entertainment (ε) category may include locations containing shopping malls, cinemas, cafés, bars, and the like. The location recommendation application 62 may create a vector Z to describe the concentration of POI categories in a particular location. In one implementation, the vector may be described as Z=<R, E, S, T> where R, E, S, and T may represent the location's restaurants, entertainment, sports, and travel relevancies respectively. Each item of the vector Z may denote the number of locations for each POI category that may be included in the region. For instance, Z=<2, 5, 0, 0> may represent a region containing two restaurants and five entertainments locations. When a region does not contain any POI categories, the location recommendation application 62 may regard the region as a travel location, i.e., Z=<0, 0, 0, 1>, because the region may indicate when one or more users exploit new tourist spots in the real world. In one implementation, each geospatial region may cover various POI categories such that multiple properties, such as restaurants and entertainments, etc. may be represented in the vector Z.

The location recommendation application 62 may use the vector Z to differentiate different locations with different profiles, filter some regions that may not be useful or attractive to the user, and understand the profile of the geographical region to reduce problems with making recommendations given too few GPS logs. For instance, if a user prefers to get recommendations related to sports, the region with the vector Z=<2, 5, 0, 0> should be filtered and not displayed to the user because there are no sport locations within the region. In one implementation, the user may indicate to the location recommendation application 62 the POI category that he may desire to visit, and the application may then identify a subset of vectors that indicate regions having a high POI concentration of the user's desired POI category. The region may be determined to have a high POI concentration of a particular category if the concentration exceeds a predetermined level. Furthermore, given two vectors, Zj and Zk, of two regions, cⱼ and cₖ, the location recommendation application 62 may be able to infer the interest or similarity of the two regions using a cosine similarity measurement as described below:

$$Sim ( {c}_{j} , {c}_{k} ) = \frac{( {Z}_{j} \cdot {Z}_{k} )}{{‖ {Z}_{j} ‖}_{2} \cdot {‖ {Z}_{k} ‖}_{2}}$$

In one implementation, the similarities between two regions may be used to enable a content-based recommendation system which may reduce problems in collaborative filtering model when new locations are entered into the model. Here, the users' ratings (accesses) on a geospatial region may be used as estimation or gauge on if these users may enjoy other locations similar to the geospatial regions they may have accessed. Therefore, when a new location is discovered, the location recommendation application 62 may be able to obtain enough ratings from multiple users to accurately predict other users' interests on it. In one implementation, the process of understanding geospatial regions may be conducted offline and may increase very slowly which may result in fewer computations.

After understanding the location, the location recommendation application 62 may proceed to step 550 and infer the user's interest in the locations not visited by the user based on the user's preference in similar geospatial regions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of making a friend recommendation to a user of a multi-user computing network, comprising:
receiving one or more location histories of the user and of other users of the computing network, each location history including real-time and non real-time user location information;
inferring location information for each user, based on specified information derived from the received location histories, the location information including one or more of:
at least one place visited by the user; and
at least one category of place visited by the user;
matching ones of the other users to the user based on similarities in the inferred location information; and
communicating to the user the matched other users as the friend recommendation.

2. The method of claim 1, wherein the matching comprises:
identifying one or more similarities between the user and the other users by comparing the inferred location information of the user with the inferred location information of the other users;
assigning similarity scores to the other users based on results of the identifying;
aggregating the assigned similarity scores for each other user to yield an aggregated score for the other user, the aggregated scores reflecting respective locational similarities between the user and the other users;
identifying one or more of the other users whose aggregated scores satisfy one or more specified criteria; and
matching the identified other users to the designated user based on similarities in the inferred location information.

3. The method of claim 2, wherein the one or more criteria include a specified threshold value and inclusion in a group of highest similarity scores.

4. The method of claim 2, wherein the matching further comprises weighting the aggregated scores based on a user selected preference and a learning heuristic.

5. The method of claim 2, wherein, in the inferring, temporal information is inferred, and wherein, in the identifying one or more similarities, the inferred temporal information of the user is compared with the inferred temproal information of the other users.

6. A computer-readable medium having stored thereon computer-executable instructions which, when executed by a computer, cause the computer to:
derive specified information from one or more received location histories of the user and of one or more other users of the computing network, each location history including real-time and non real-time user location information;
infer location information for each user from the derived information, the location information including at least one of:
one or more places visited by the user; and
one or more categories of places visited by the user;
identify similarities between the respective inferred location information of the user and each other user; and
recommend that the user befriend ones of the other users based on the identifying.

7. The computer-readable medium of claim 6, wherein the computer-executable instructions which, when executed by a computer, cause the computer to identify similarities between the respective inferred location information of the user and each other user, comprise computer-executable instructions which, when executed by a computer, cause the computer to:
identify one or more similarities between the user and the other users by comparing the inferred location information of the user with the inferred location information of the other users;
assign similarity scores to the other users based on results of the identifying;
aggregate the assigned similarity scores for each other user to yield an aggregated score for the other user, the aggregated scores reflecting respective locational similarities between the user and the other users; and
identify one or more of the other users whose aggregated scores satisfy one or more specified criteria.

8. A computer system, comprising:
a processor; and
a memory comprising program instructions executable by the processor to:
receive one or more location histories of the user and of other users of the computing network, each location history including real-time and non real-time user location information;
infer location information for each user, based on specified information derived from the received location histories, the location information including one or more of:
at least one place visited by the user; and
at least one category of place visited by the user;
match ones of the other users to the user based on similarities in the inferred location information; and
communicate to the user the matched other users as the friend recommendation.

9. The computer system of claim 8, wherein the program instructions executable by the processor to match ones of the other users to the user comprise program instructions executable by the processor to:
identify one or more similarities between the user and the other users by comparing the inferred location information of the user with the inferred location information of the other users;
assign similarity scores to the other users based on results of the identifying;
aggregate the assigned similarity scores for each other user to yield an aggregated score for the other user, the aggregated scores reflecting respective locational similarities between the user and the other users;
identify one or more of the other users whose aggregated scores satisfy one or more specified criteria; and
match the identified other users to the designated user based on similarities in the inferred location information.

10. The computer system of claim 9, wherein the one or more criteria include a specified threshold value and inclusion in a group of highest similarity scores.

11. The computer system of claim 9, wherein the program instructions executable by the processor to match ones of the other users to the user comprise program instructions executable by the processor to weight the aggregated scores based on a user selected preference and a learning heuristic.

12. The computer system of claim 9, wherein the program instructions executable by the processor to infer location information comprise program instructions executable by the processor to infer temporal information, and
wherein the program instructions executable by the processor to identify one or more similarities comprise program instructions executable by the processor to compare the inferred temporal information of the user with the inferred temporal information of the other users.
